(19) United States
(12) Patent Application Publication
(10) Pub. No.: US 2025/0209959 A1
(43) Pub. Date: Jun. 26, 2025

(54) PANEL DRIVING METHOD AND PANEL DRIVING SYSTEM

(71) Applicant: MACROBLOCK,INC., Hsinchu City (TW)

(72) Inventors: WenChi WANG, Hsinchu City (TW); Shihying TANG, Hsinchu City (TW); Rong Fu LIN, Hsinchu City (TW)

(73) Assignee: MACROBLOCK,INC., Hsinchu City (TW)

(21) Appl. No.: 18/921,783

(22) Filed: Oct. 21, 2024

(30) Foreign Application Priority Data
Dec. 25, 2023 (TW) 112150597

(51) Int. Cl. G09G 3/20

(52) U.S. Cl. CPC G09G 3/2092; G09G 2300/026; G09G 2310/08; G09G 2340/0407

(57) ABSTRACT

A panel driving method for spliced display devices with a plurality of panel modules is provided, and the method comprising: by an image generation circuit, generating an initial image with an initial resolution receiving image data; by an image dispatch circuit, generating an advanced image with a terminal resolution based on the initial image and an application setting value, and further dividing the advanced image into a plurality of terminal images; and, by a plurality of timing controllers, receiving the terminal images individually, generating a plurality of panel driving signals corresponding to the terminal images, and outputting the panel driving signals to the panel modules. The image dispatch circuit determines whether to scale the initial image as the advanced image based on whether the value of the initial resolution is equal to the application setting value.

### CROSS-REFERENCE TO RELATED APPLICATIONS

This non-provisional application claims priority under 35 U.S.C. § 119(a) on Patent Application No(s). 112150597 filed in Republic of China on Dec. 25, 2023, the entire contents of which are hereby incorporated by reference.

### BACKGROUND

### 1. Technical Field

This disclosure relates to a panel driving method and panel driving system.

### 2. Related Art

Traditionally, in a typical spliced display device, after receiving the image data, the image is scaled only once by a scaler IC, and then the image is divided by a field programmable gate array (FPGA), and then outputted to a timing controller. However, in practice, when the implementation is applied to panel modules connected to the back-end of the mentioned architecture above, particularly in the spliced display market where customization is frequently required, this approach often fails to fully match the resolution of the back-end panel modules, thereby affecting the image display quality of the spliced display device.

### SUMMARY

In view of the above description, this disclosure provides a panel driving method and a panel driving system.

According to an embodiment of the panel driving method of this disclosure, which is applied to a spliced display device comprising a plurality of panel modules, the method includes: by an image generation circuit, receiving an original image and scaling the original image to generate an initial image having an initial resolution; by an image dispatch circuit, receiving the initial image and an application setting value and generating an advanced image having a terminal resolution; by the image dispatch circuit, dividing the advanced image into a plurality of terminal images; by a plurality of timing controllers, receiving the plurality of terminal images, respectively, and generating a plurality of panel driving signals corresponding to the plurality of terminal images; and by the plurality of timing controllers, outputting the plurality of panel driving signals to the plurality of panel modules, respectively. Wherein generating the advanced image having the terminal resolution includes: determining whether a value of the initial resolution is equal to the application setting value, setting the initial image as the advanced image when determining the value of the initial resolution is equal to the application setting value, scaling the initial image to generate the advanced image when determining the value of the initial resolution is not equal to the application setting value, and a value of the terminal resolution of the advanced image is equal to the application setting value.

According to an embodiment of the panel driving system of this disclosure, which is applied to a spliced display device comprising a plurality of panel modules, includes: an image generation circuit, an image dispatch circuit, and a plurality of timing controllers. The image generation circuit receives an original image and scales the original image to generate an initial image having an initial resolution. The image dispatch circuit is electrically connected to the image generation circuit, and the image dispatch circuit receives the initial image and an application setting value, generates an advanced image having a terminal resolution, and divides the advanced image into a plurality of terminal images. The plurality of timing controllers is electrically connected to the image dispatch circuit, receives the plurality of terminal images respectively, generates a plurality of panel driving signals corresponding to the plurality of terminal images, and outputs plurality of the panel driving signals to the plurality of panel modules, respectively. The image dispatch circuit determines whether a value of the initial resolution is equal to the application setting value, sets the initial image as the advanced image when determining the value of the initial resolution is equal to the application setting value, and scales the initial image to generate the advanced image when determining the value of the initial resolution is not equal to the application setting value, and a value of the terminal resolution of the advanced image is equal to the application setting value.

Through the aforementioned structure and operational method, the panel driving method and panel driving system of this disclosure may be more suitable for customized spliced display device and achieve better display performance by selectively performing a second resolution adjustment to the initial image during image dispatch.

The above description of the content of this disclosure and the following description of the embodiments are provided to illustrate and explain the spirit and principles of the present invention and to further explain the scope of the patent claims of the present invention.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a panel driving system according to an embodiment of the present invention;

FIG. 2 is a flow chart illustrating a panel driving method according to an embodiment of the present invention; and

FIG. 3 is a flow chart illustrating the determination of step S2 of the panel driving method according to an embodiment of the present invention.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

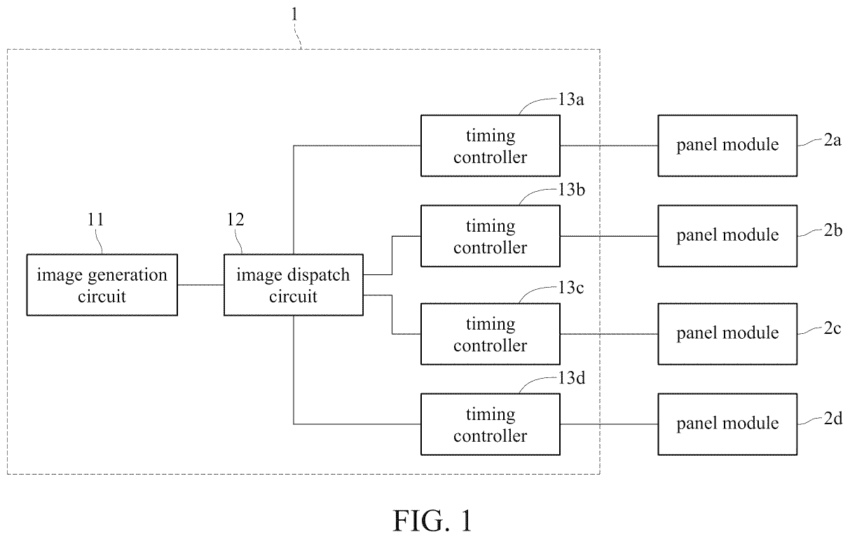

Please refer to FIG. 1, which is a block diagram illustrating the panel driving system according to an embodiment of the present invention. As shown in FIG. 1, the spliced display device includes a panel driving system 1 and a plurality of panel modules 2a to 2d controlled by the panel driving system 1, wherein the number of the panel modules 2a to 2d is not limited to four, and the spliced display device using the panel driving system of the present invention is not limited in terms of the number of panel modules.

As stated above, as shown in FIG. 1, the panel driving system 1 of the embodiment includes an image generation circuit 11, an image dispatch circuit 12, and a plurality of timing controllers 13a to 13d. The image generation circuit 11 is configured to receive an original image and perform reduction or enlargement (hereinafter referred to as scaling) to generate an initial image based on the original image, and this initial image has an initial resolution. The image dispatch circuit 12 is electrically connected to the image generation circuit 11 to receive the initial image from the image generation circuit 11, and the image dispatch circuit 12 further receives an application setting value, thereby generating an advanced image with a terminal resolution and dividing this advanced image into a plurality of terminal images. The timing controllers 13a to 13d receive the aforementioned terminal images respectively, and after generating a plurality of panel driving signals corresponding to the terminal images, outputs the plurality of panel driving signals to the panel modules 2a to 2d, respectively. Similarly, the number of timing controllers 13a to 13d is not limited to four, and the number of timing controllers 13a to 13d corresponds to the number of panel modules 2a to 2d. Especially, when the aforementioned image dispatch circuit 12 generates the advanced image, the image dispatch circuit 12 first compares the value of the initial resolution of the initial image with the application setting value and then determines how to generate the advanced image based on the comparison result. In detail, when the value of the initial resolution is equal to the application setting value, the initial image is used as the advanced image for division; and when the value of the initial resolution is not equal to the application setting value, the initial image is scaled to generate the advanced image so that the value of the terminal resolution of the advanced image equals the application setting value.

In the above embodiment, the original image has an original resolution, and the original resolution differs from the initial resolution. Additionally, each timing controller 13 has an address, so that the image dispatch circuit 12 can transmit each of the terminal images to the corresponding timing controller 13 based on the addressing method. Moreover, it is preferable that each timing controller 13 has a buffer memory to store the terminal images received from the image dispatch circuit 12, and the timing controller 13 may further correct the terminal images when the timing controller 13 generates the panel driving signals corresponding to the terminal images, for example, by performing color and brightness calibration and optimization, as well as adding additional image effects.

In an embodiment, the image generation circuit 11 may be implemented by a scaler integrated circuit (scaler IC), the image dispatch circuit 12 may be implemented by a field programmable gate array (FPGA), the timing controllers 13a to 13d may be implemented by timing control integrated circuits (TCON IC), and the panel modules 2a to 2d which receive the panel driving signals may be, for example, liquid crystal display modules, organic light emitting diode display modules, plasma display modules, etc., but are not limited to the aforementioned types of display modules.

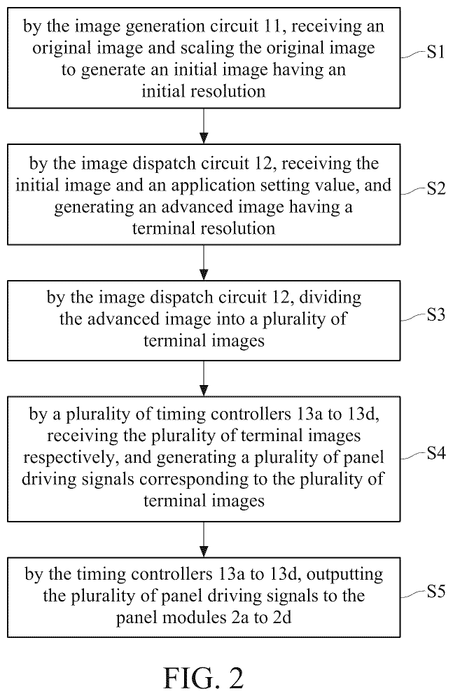

Please refer to FIG. 1 and FIG. 2 together, wherein FIG. 2 is a flow chart illustrating a panel driving method according to an embodiment of the present invention, and includes steps S1 to S5. Step S1 is “by the image generation circuit 11, receiving an original image and scaling the original image to generate an initial image having an initial resolution”, wherein the initial resolution may be a resolution suitable for a standard spliced display device, and the image generation circuit 11 is used to scale the original image to generate the initial image having the initial resolution. Step S2 is “by the image dispatch circuit 12, receiving the initial image and an application setting value, and generating an advanced image having a terminal resolution”, wherein the application setting value is the resolution value set for the spliced display device on which this panel driving method is being implemented, and this allows the image dispatch circuit 12 to generate an advanced image with a resolution most suitable for the specifications of the spliced display device (for example, a specially customized specification). Step S3 is “by the image dispatch circuit 12, dividing the advanced image into a plurality of terminal images”, wherein the plurality of terminal images may directly or indirectly constitute the complete image of the spliced display device. Step S4 is “by the plurality of timing controllers 13a to 13d, receiving the plurality of terminal images respectively, and generating a plurality of panel driving signals corresponding to the plurality of terminal images”, wherein the plurality of timing controllers 13a to 13d are configured to generate signals for driving each of the panel modules of the spliced display device based on the plurality of terminal images, respectively. During the generation process, image correction or adding special effects may also be performed. Step S5 is “by the timing controllers 13a to 13d, outputting the plurality of panel driving signals to the panel modules 2a to 2d, respectively”, thereby completing the driving of the spliced display device.

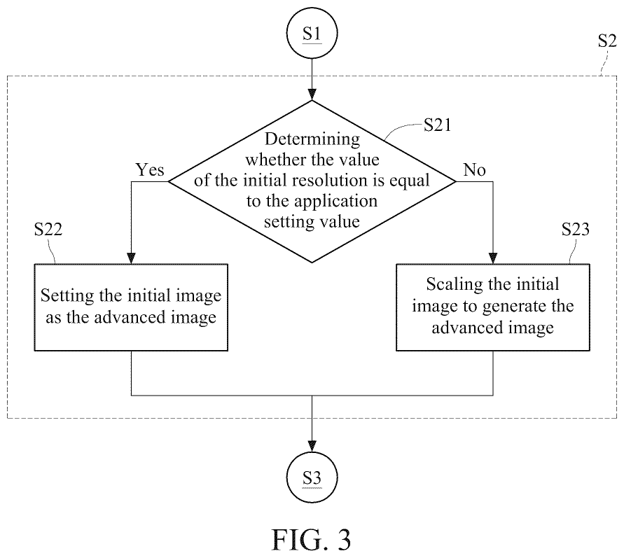

Please further refer to FIG. 3, which is a determination flow chart of step S2 in the panel driving method according to an embodiment of the present invention. In detail, step S2 may include sub-steps S21, S22, and S23. Sub-step S21 is “determining whether the value of the initial resolution is equal to the application setting value”, thereby determining how to continue generating the advanced image based on the determination result. When the determination result is “yes”, sub-step S22 is executed, and when the determination result is “no”, sub-step S23 is executed. Sub-step S22 is “setting the initial image as the advanced image”, meaning that the initial image does not need to be adjusted as it has already conformed to the specifications of the spliced display device in terms of resolution. Sub-step S23 is “scaling the initial image to generate the advanced image”, meaning that the specification of the current spliced display device is not a standard specification, so further scaling of the initial image is required to obtain the most suitable advanced image. The present invention does not limit the method of obtaining the application setting value described herein, and the application setting value may be directly set in the image dispatch circuit 12 by the user according to the actual specification of the spliced display device, or the application setting value may also be information returned to the image dispatch circuit 12 by the timing controllers 13a to 13d or the panel modules 2a to 2d based on the actual specifications of the panels.

Through the aforementioned structure and operational method, the panel driving method and panel driving system of this disclosure may be more suitable for customized spliced display devices and achieve better display performance by selectively performing a second resolution adjustment to the initial image during image dispatch.

Although the present invention has been disclosed through the aforementioned embodiments, it is not intended to limit the invention. Any modifications and refinements made without departing from the spirit and scope of the present invention are within the scope of patent protection for this invention. For the scope of protection defined by the present invention, please refer to the appended claims.

What is claimed is:

1. A panel driving method, applied to a spliced display device comprising a plurality of panel modules, and the method comprising:
by an image generation circuit, receiving an original image and scaling the original image to generate an initial image having an initial resolution;
by an image dispatch circuit, receiving the initial image and an application setting value and generating an advanced image having a terminal resolution;
by the image dispatch circuit, dividing the advanced image into a plurality of terminal images;
by a plurality of timing controllers, receiving the plurality of terminal images, respectively, and generating a plurality of panel driving signals corresponding to the plurality of terminal images; and
by the plurality of timing controllers, outputting the plurality of panel driving signals to the plurality of panel modules, respectively,
wherein generating the advanced image having the terminal resolution includes: determining whether a value of the initial resolution is equal to the application setting value, setting the initial image as the advanced image when determining the value of the initial resolution is equal to the application setting value, scaling the initial image to generate the advanced image when determining the value of the initial resolution is not equal to the application setting value, and a value of the terminal resolution of the advanced image is equal to the application setting value.

2. The panel driving method according to claim 1, wherein receiving the plurality of terminal images by the plurality of timing controllers comprises: by the image dispatch circuit, outputting the plurality of terminal images based on a plurality of address of the plurality of timing controllers, respectively.

3. The panel driving method according to claim 1, wherein before generating the plurality of panel driving signals corresponding to the plurality of terminal images, the method further comprises: by the plurality of timing controllers, storing the plurality of terminal images received from the image dispatch circuit.

4. A panel driving system, applied to a spliced display device comprising a plurality of panel modules, comprising:
an image generation circuit receiving an original image and scaling the original image to generate an initial image having an initial resolution;
an image dispatch circuit electrically connected to the image generation circuit, the image dispatch circuit receiving the initial image and an application setting value, generating an advanced image having a terminal resolution, and dividing the advanced image into a plurality of terminal images; and
a plurality of timing controllers electrically connected to the image dispatch circuit, receiving the plurality of terminal images, respectively, generating a plurality of panel driving signals corresponding to the plurality of terminal images, and outputting plurality of the panel driving signals to the plurality of panel modules, respectively;
wherein the image dispatch circuit determines whether a value of the initial resolution is equal to the application setting value, sets the initial image as the advanced image when determining the value of the initial resolution is equal to the application setting value, and scales the initial image to generate the advanced image when determining the value of the initial resolution is not equal to the application setting value, and a value of the terminal resolution of the advanced image is equal to the application setting value.

5. The panel driving system according to claim 4, wherein the image dispatch circuit is a field programmable gate array.

6. The panel driving system according to claim 4, wherein the image dispatch circuit outputs the plurality of terminal images based on a plurality of addresses, corresponding to the plurality of timing controllers, respectively.

7. The panel driving system according to claim 4, wherein the plurality of timing controllers stores the plurality of terminal images received from the image dispatch circuit, respectively.
